(19) United States
(12) Patent Application Publication
(10) Pub. No.: US 2005/0169415 A1
(43) Pub. Date: Aug. 4, 2005

(54) Timing error recovery system

(75) Inventors: Aravind Nayak, Longmont, CO (US); German Stefan Otto Feyh, Boulder, CO (US)

Correspondence Address: KINNEY & LANGE, PA, THE KINNEY & LANGE BUILDING, 312 SOUTH 3RD STREET, MINNEAPOLIS, MN, 55415, US

(73) Assignee: Agere Systems Inc., Allentown, PA (US)

(21) Appl. No.: 11/047,377

(22) Filed: Jan. 31, 2005

Related U.S. Application Data
(60) Provisional application No. 60/540,527, filed on Jan. 30, 2004.

(51) Int. Cl. H04B 17/00

(52) U.S. Cl. 375/355

(57) ABSTRACT

A timing error recovery system includes a phase locked loop that receives a continuous time input signal, samples the input signal at a sampling rate and generates a voltage control signal. A statistical estimator, such as a maximum a posteriori estimator, compares the voltage control signal with an expected error based upon a statistical model and produces an adjusted voltage control signal that drives a voltage controlled oscillator to adjust the sampling rate.

### CROSS-REFERENCE TO RELATED APPLICATION(S)

This application claims priority from Provisional Application 60/540,527, filed Jan. 30, 2004 entitled “Maximum a Posteriori (MAP) Timing Recovery” by A. Nayak and G. Feyh.

### INCORPORATION BY REFERENCE

The aforementioned Provisional Application 60/540,527 is hereby incorporated by reference in its entirety.

### BACKGROUND OF THE INVENTION

The invention relates generally to timing recovery in data storage systems. In particular, the present invention relates to using a maximum a posteriori (MAP) timing recovery estimator to determine and correct the error in a magnetic recording channel signal.

Timing recovery is an important part of data storage systems. A common method of timing recovery is based on a phase-locked loop (PLL). Essentially, the PLL is a feedback loop that continually updates a sampling rate clock based on successive signal samples. This results in an error signal, which the PLL then uses to correct the sampling rate.

While use of a PLL reduces signal error, there is still significant error in the signal. The present invention, in an exemplary embodiment, uses a statistical estimator such as a maximum a posteriori (MAP) estimator to compare the error signal pattern generated by a PLL with an expected error signal pattern derived from a statistical model. The comparison of the actual and expected error signal pattern is then used to correct the sampling pattern. This second level of error detection results in significantly better performance than a PLL alone.

### BRIEF SUMMARY OF THE INVENTION

A timing error recovery system according to an exemplary embodiment of the present invention includes a phase locked loop that receives a continuous time input signal, samples the input signal at a sampling rate and generates a voltage control signal. A statistical estimator compares the voltage control signal with an expected error value based upon a statistical model and produces an adjusted voltage control signal that drives a voltage controlled oscillator to adjust the sampling rate.

In another embodiment of the invention, a timing error recovery system includes a phase locked loop that receives a continuous time input signal, samples the input signal at a sampling rate to create a digital input signal and generates a voltage control signal. The voltage control signal drives a voltage controlled oscillator in the phase locked loop to adjust the sampling rate. A statistical estimator compares the voltage control signal with an expected error value based upon a statistical model and produces an adjusted voltage control signal that drives a second voltage controlled oscillator that generates adjusted sampling instants. A resampler uses the adjusted sampling instants to select an adjusted sampling rate. The resampler receives the digital input signal and produces digital samples corresponding to the adjusted sampling rate.

### BRIEF DESCRIPTION OF THE DRAWINGS

FIG. 1 is a diagram illustrating the general configuration of a timing error recovery system according to an exemplary embodiment of the present invention.

FIG. 2 is a diagram illustrating the general configuration of another exemplary embodiment of a timing error recovery system according to the present invention.

FIG. 3 is a graph showing the performance of a MAP estimator compared with the Cramer-Rao Bound.

### DETAILED DESCRIPTION

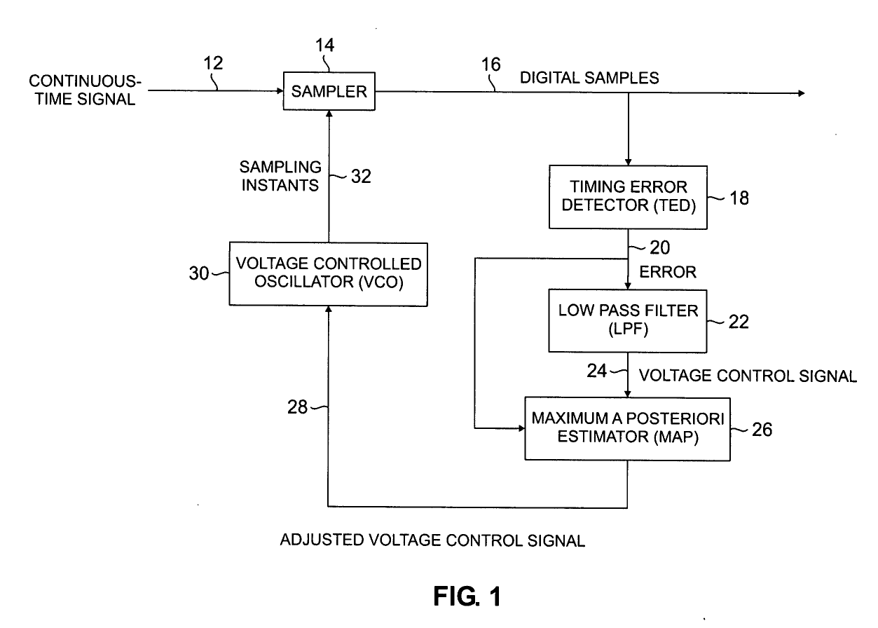

FIG. 1 shows an exemplary implementation of the present invention. Continuous time signal 12 is sampled by sampler 14, resulting in digital samples 16. Timing error detector (TED) 18 (sometimes referred to as a phase error detector or phase error comparator) receives digital samples 16 as an input signal, compares them to a reference signal, and generates error signal 20. Error signal 20 is operated on by low pass filter 22 to produce voltage control signal 24. The structure described thus far is part of a conventional PLL.

The present invention improves the conventional PLL by adding a statistical estimator, such as MAP estimator 26, to the circuit. The error represented by error signal 20 results from different sized gaps, also known as timing offsets, in digital samples 16. Digital data takes the form of a series of ones and zeros separated by spacing gaps. However, the size of every gap between the ones and zeros in a data stream is not the same. A PLL does not assume any prior information about the timing offsets between the data bits. Therefore, the error signal and correction generated by a PLL may be improved if appropriate prior information is used.

In many cases, it is known that the timing offsets follow a statistical distribution. Therefore, voltage control signal 24, which is an actual error signal generated by a PLL, is examined and compared with an expected error, which is based on a statistical model. MAP estimator 26 maps the value of voltage control signal 24 onto a model of expected values, resulting in adjusted voltage control signal 28, which drives VCO 30 to produce sampling instants 32. Sampler 14 receives sampling instants 32, and sampler 14 adjusts its sampling rate based upon the sampling instants.

MAP estimators are known in the art. (See, e.g., H. Van Trees, Detection, Estimation, and Modulation Theory: Part I, John Wiley & Sons (1968). The PLL generates a value indicative of the difference between the observed value and the expected value. For example, one may have expected values that are plotted on a two-dimensional plane as a straight line with a slope of one that passes through the origin. However, an actual measured value could be any point in the plane, spaced apart from the straight line that represents the expected values. In two-dimensional space, the difference between the observed value and the expected value is resolved by projecting the point representing the observed value onto the line representing the expected values. The difference between the observed value and the expected value is the vector from the observed value to the point that is at the intersection of the line representing the set of expected values and the line that is perpendicular to this expected values line and that passes through the point representing the observed value.

In processing a data stream, one must generally analyze N-dimensional space. A PLL generates a vector indicative of the difference between an observed value and an expected value. The timing error recovery system shown in FIG. 1 utilizes a statistical estimator such as MAP estimator 26 to project the vector generated by the PLL onto N-dimensional space, where each timing offset represents an additional dimension in space. The projection is then used to generate the adjusted voltage control signal.

As with any estimation, the output of the statistical estimator depends upon the accuracy of the statistical model used. Expected values used by the statistical estimator may be based upon empirical knowledge of a hard drive, or may also be obtained by disassembling a hard drive and measuring certain parameters. It has been found that the random walk model, which is known in the art, is a good model of expected timing offsets. However, other models could also be used.

Statistical estimator 26 compares the error signal pattern generated by a PLL with an expected error signal pattern derived from a statistical model. The comparison of the actual and expected error signal pattern is then used to correct the sampling pattern. The embodiments of the present invention described herein use a MAP estimator because the MAP estimator has been found to work particularly well. However, any kind of statistical estimator could be used in place of, or in addition to, a MAP estimator to implement the invention.

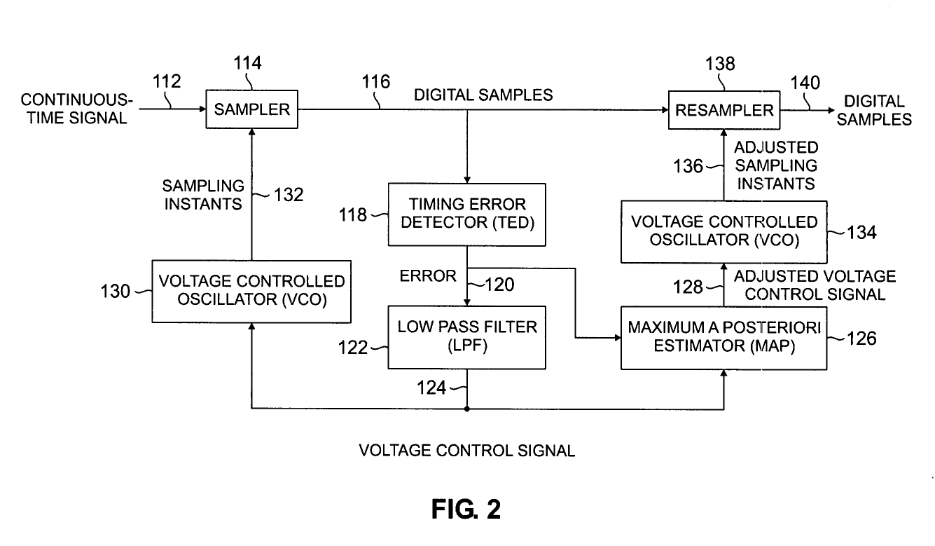

FIG. 2 shows another exemplary implementation of the present invention. Continuous time signal 112 is sampled by sampler 114, resulting in digital samples 116. TED 118 receives digital samples 116 as an input signal, compares them to a reference signal and generates error signal 120. Error signal 120 is operated on by low pass filter 122 to produce voltage control signal 124. MAP estimator 126 receives voltage control signal 124 and compares it to a statistical model, as described with respect to the embodiment shown in FIG. 1. MAP estimator 126 generates adjusted control signal 128. Voltage controlled oscillator 130 also receives voltage control signal 124 and generates sampling instants 132, which are used by sampler 114 to select a sampling rate. Voltage controlled oscillator 134 receives adjusted voltage control signal 128 as an input and generates adjusted sampling instants 136. Resampler 138 receives adjusted sampling instants 136 and produces digital samples 140 corresponding to adjusted sampling instants 136. In this embodiment of the invention, the MAP estimator does not affect the voltage control signal at all in the left half of the loop. Rather, it takes the digital samples produced by the sampler and then produces new digital samples based on the timing information from the MAP estimator. This results in improved digital samples.

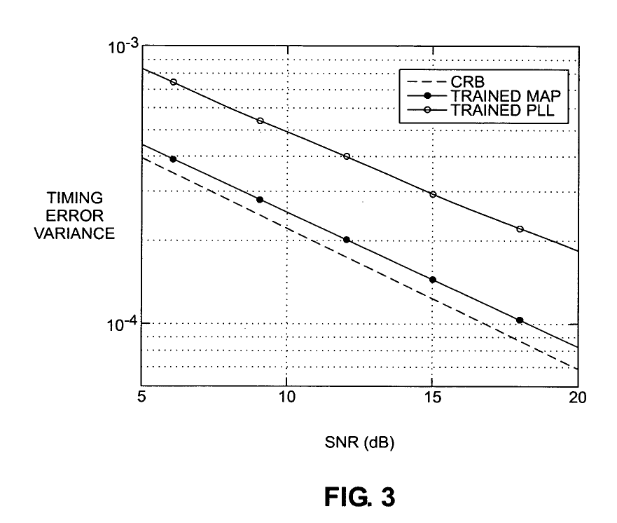

The Cramer-Rao Bound (CRB) is a lower bound on the error variance of estimators. It is commonly used as a benchmark to evaluate the performance of estimators. For an exemplary system considered in testing simulations, the PLL performs to within about 7 dB of the CRB. FIG. 3 compares the performance of the embodiment of the MAP timing recovery invention shown in FIG. 2 with a conventional PLL. The MAP timing recovery circuit performs to within 1.5 dB of the CRB, which is about 5.5 dB better than the PLL.

In practice, a MAP estimator utilizes complex matrix operations that become computationally burdensome or unfeasible for the block lengths of 5000 that are common in the magnetic recording industry. Therefore, it is important to develop simplifications that will allow the MAP estimator to be used in practice. These simplifications are implemented inside MAP estimator 26 (FIG.1) and MAP estimator 126 (FIG. 2). Simplified forms of the MAP estimator use significantly less memory, yet perform sufficiently well for most practical implementations.

For example, the MAP estimator matrix may be written as:
τmap(y)=K_{ε}y
where y is the input signal, τmap(y) is the MAP estimator matrix and K_{ε} is the error covariance matrix for the MAP estimator. A shaping function may be written as:
ƒ=ƒ₁/ƒ₁(N/2)
where f₁ is the N×1 vector containing the main diagonal of K₆₈ . Then the MAP estimator matrix may be approximated by:
τmap(y)≈A₁A₂y
where A₁ is a diagonal matrix with the ith main diagonal entry being f(i) and A₂ is the matrix whose rows are the shifted rows defined by
rowᵢ≈shift (g, N/2−i, left)
where g represents the (N/2)th row of K_{ε} and the shift operator shifts the entries of the first argument by the amount specified in the second argument, with the direction of shift specified in the third argument. This approximation simplifies implementation of the MAP estimator because A₂ represents a convolution matrix and can be implemented as a time-invariant filter whose impulse response is g. A₁ can be implemented as time-varying scaling of the filter output. To further reduce complexity, A₁ may be neglected altogether. In addition, the filter may be truncated to reduce complexity of the operation.

These approximations perform practically as well as the general matrix operation of the MAP estimator, while using significantly less memory. The matrix operation requires N² memory elements, while the simplified operation requires only 2N memory elements. Neglecting the scaling function and implementing only the filtering function reduces the memory requirement to N elements. In addition, it also allows a time-invariant filter implementation of the MAP estimator.

The present invention, as described above with respect to exemplary embodiments, uses a statistical estimator such as a MAP estimator to compare the error signal pattern generated by a PLL with an expected error signal pattern derived from a statistical model. The comparison of the actual and expected error signal pattern is then used to correct the sampling pattern. This second level of error detection results in significantly better performance than a PLL alone. In addition, simplified forms of the statistical estimator, which use only scaling and filtering operations, may be implemented. The simplified forms of the MAP estimator use significantly less memory, yet perform sufficiently well for most practical implementations.

Although the present invention has been described with reference to preferred embodiments, workers skilled in the art will recognize that changes may be made in form and detail without departing from the spirit and scope of the invention.

1. A timing error recovery system comprising:
a timing error detector generating an error signal representative of an error in timing of sampling a data signal; and
a statistical estimator comparing the error signal generated by the timing error detector with an expected error to produce an adjusted control voltage signal for driving a first voltage controlled oscillator to sample the data signal with adjusted timing.

2. The timing error recovery system of claim 1, wherein the timing error detector and the first voltage controlled oscillator are configured in a phase locked loop.

3. The timing error recovery system of claim 1, further comprising:
a second voltage controlled oscillator that is configured with the timing error detector in a phase locked loop;
wherein the second voltage controlled oscillator is driven by an unadjusted voltage control signal based on the error signal generated by the timing error detector, the second voltage controlled oscillator sampling the data signal based on the unadjusted voltage control signal and the first voltage controlled oscillator providing adjusted sampling instants to a resampler that produces digital samples at an adjusted sampling rate.

4. The timing error recovery system of claim 1 wherein the statistical estimator is a maximum a posteriori estimator.

5. The timing error recovery system of claim 1 wherein the expected error is derived from a statistical model.

6. The timing error recovery system of claim 1 wherein the expected error is derived from a random walk model.

7. The timing error recovery system of claim 1 wherein the expected error is derived from empirical knowledge of a hard drive.

8. The timing error recovery system of claim 1 wherein the voltage control signal is a vector, the expected error is in N-dimensional space, and the voltage control signal is mapped onto the expected error.

9. The timing error recovery system of claim 1 wherein the error signal is compared to the expected error by using a filtering function.

10. The timing error recovery system of claim 1 wherein the error signal is compared to the expected error by using a filtering function and a scaling function.

11. A method for correcting timing error, the method comprising:
receiving an input signal;
sampling the input signal at a sampling rate;
comparing the sampled input signal to a reference signal to produce an error signal;
comparing the error signal to an expected error to produce an adjusted control voltage; and
adjusting the sampling rate based upon the adjusted control voltage.

12. The method of claim 11 wherein the error signal and expected error are compared by a maximum a posteriori estimator.

13. The method of claim 11 wherein the expected error is derived from a statistical model.

14. The method of claim 13 wherein the expected error is derived from a random walk model.

15. The method of claim 11 wherein the expected error is derived from empirical knowledge of a hard drive.

16. The method of claim 11 wherein the error signal is a vector, the expected error is in N-dimensional space, and the error signal is mapped onto the expected error.

17. The method of claim 11 wherein the error signal is compared to the expected error by using a filtering function.

18. The method of claim 11 wherein the error signal is compared to the expected error by using a filter function and a scaling function.
